(19) United States
(12) Patent Application Publication
(10) Pub. No.: US 2013/0042658 A1
(43) Pub. Date: Feb. 21, 2013

(54) LEASH WITH SECURITY FEATURE

(71) Applicant: James C. Allen, JR., Scottsdale, AZ (US)

(72) Inventor: James C. Allen, JR., Scottsdale, AZ (US)

(21) Appl. No.: 13/212,033

(22) Filed: Aug. 17, 2011

(51) Int. Cl. E05B 73/00; A01K 27/00

(52) U.S. Cl. 70/58

(57) ABSTRACT

A conventional leash includes a snap fitting for attachment to a ring extending from a collar about the neck of an animal. A lockable cover is detachably attached about the snap fitting to prevent unauthorized detachment of the leash from the ring. A wire or the like may extend along or be embedded in the leash to prevent cutting of the leash by a conventional knife or a pair of scissors. A similar lockable cover is detachably attached about a buckle of the collar to prevent removal of the collar from about the neck of the animal.

### BACKGROUND OF THE INVENTION

1. Field of the Invention

The invention relates to security devices for use with animal leashes and, more particularly, to a security device for preventing detachment of a leash from an animal collar.

2. Description of Related Prior Art

In the normal course of walking a dog in a city or municipality, leash laws usually exist requiring that such animal be attached to a leash at all times. Eating establishments and stores generally do not permit the leashed animal to enter. An exception relates to seeing-eye dogs.

Prior to entering the store or eating establishment, the dog walker must secure the leash to some outside structure. After the dog walker enters the store or eating establishment, the dog is left alone and depending upon temperament of the dog, it is more or less friendly with passersby.

If a passerby sees the dog and establishes a rapport with the dog, it is an easy matter to unhook the leash from the dog's collar and take the dog away. Such theft occurs quite often, especially with pedigreed dogs or dogs that are particularly friendly with a passerby. The likelihood of the owner recovering the dog is generally very remote.

### SUMMARY OF THE INVENTION

The end of a conventional leash includes a snap fitting for selective engagement with a ring attached to a collar for an animal, such as a dog. Generally, the snap fitting is relatively easily attached and detached from the ring by a thumb operated slide. To prevent unauthorized detachment of the snap fitting, a lockable cover in the manner of a security device enfolds a part of the ring and the snap fitting to preclude movement of the slide. The cover includes two parts hingedly attached along one side in a clamshell-like manner. The other side includes locking apparatus to prevent unauthorized opening of the cover. Thereby, unwanted disengagement of the snap fitting from the collar supported ring is precluded. To prevent cutting of the leash or collar, a wire or other difficult-to-sever element may extend along or be embedded within the leash or the collar.

It is therefore a primary object of the prevent invention to provide a security device to prevent disengagement of a leash from an animal mounted collar.

Another object of the present invention is to provide a cover for enfolding the snap fitting of a leash.

Still another object of the present invention is to provide a lockable cover for preventing access to the connecting element between a leash and an animal collar.

Yet another object of the present invention is to provide a lockable device for preventing unauthorized disengagement of a leash from a dog collar.

A further object of the present invention is to provide a security device lockably interconnecting a leash and a dog collar, which leash includes a security element for discouraging cutting of the leash.

A still further object of the present invention is to provide a method for enveloping and securing the element interconnecting a leash with a dog collar.

A yet further object of the present invention is to provide a tamperproof method for securing a leash to a dog collar.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a security device enveloping the point of attachment of a leash to a collar worn by a dog and a further security device enveloping the buckle of the collar;

FIG. 2 illustrates a security device enveloping the buckle of a dog collar;

FIG. 3 is a partial cross-sectional view of the security device shown in FIG. 2;

FIG. 4 illustrates a security device in cross-section and enveloping the snap fitting of a leash and a part of the ring extending from a collar;

FIG. 5 illustrates the security device shown in FIG. 4 in the open state;

FIG. 6 illustrates the security device shown in FIGS. 4 and 5 in the closed state;

FIG. 7 illustrates the security device in a closed state and having a key operated lock;

FIG. 8 illustrates closing of the security device shown in FIG. 7;

FIG. 9 illustrates the security device with a thumb wheel lock; and

FIG. 10 illustrates the security device shown in FIG. 9 in the open position.

### DESCRIPTION OF THE PREFERRED EMBODIMENT

FIG. 1 illustrates a representative animal, such as a dog, wearing a collar 10. A leash 12 is attached to a ring 18 on the collar in the conventional manner. A security device 14 may be attached to the collar to envelope the buckle of the collar and prevent unbuckling of the collar from about the animal's neck. Another security device 16 envelops a conventional snap fitting at the end of leash 12 that engages ring 18 extending from collar 10. Leash 12 includes a conventional loop 20 for holding the leash and for securing the leash to an anchor of some type to retain the animal in proximity to such anchor.

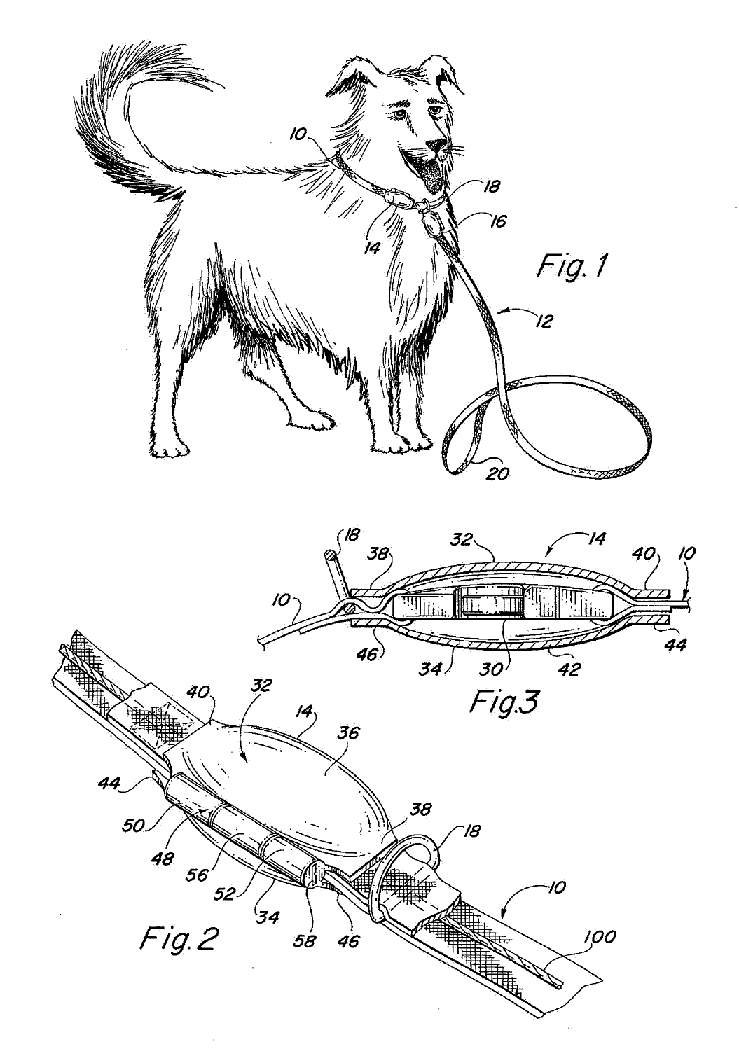

Referring jointly to FIGS. 2 and 3, there is shown a security device 14 for enveloping a buckle 30, which buckle secures the ends of collar 10 about the neck of the animal. The security device includes two clamshell-like elements 32, 34 hingedly attached to one another (as shown in FIG. 10). Element 32 includes an elongated dome 36 terminated at opposed ends by planar sections 38, 40. Similarly, element 34 includes an elongated dome 42 terminated at opposed ends by planar sections 44, 46.

To secure elements 32, 34 to one another and prevent access to buckle 30, a locking mechanism 48 may be affixed to the sides of elements 32, 34 opposite to the connecting hinge (see FIG. 10). The locking mechanism may include two cylinders 50, 52 extending from the edge of element 34 and a cylinder 56 extending from the edge of element 32. As illustrated, cylinder 52 may include a keyhole 58 for receiving a key to lock and unlock cylinder 56 between cylinders 50, 52.

Planar sections 38, 46 are displaced from one another a sufficient distance to capture the portion of collar 10 disposed therebetween, which distance is insufficient to permit pass-through of buckle 30. Similarly, planar sections 40, 44 are displaced a sufficient distance from one another sufficient to locate collar 10 therebetween and yet not permit pass-through of the buckle.

By employing security device 14 to envelop buckle 30 of collar 10, disengagement of the collar from about the neck of the animal is prevented.

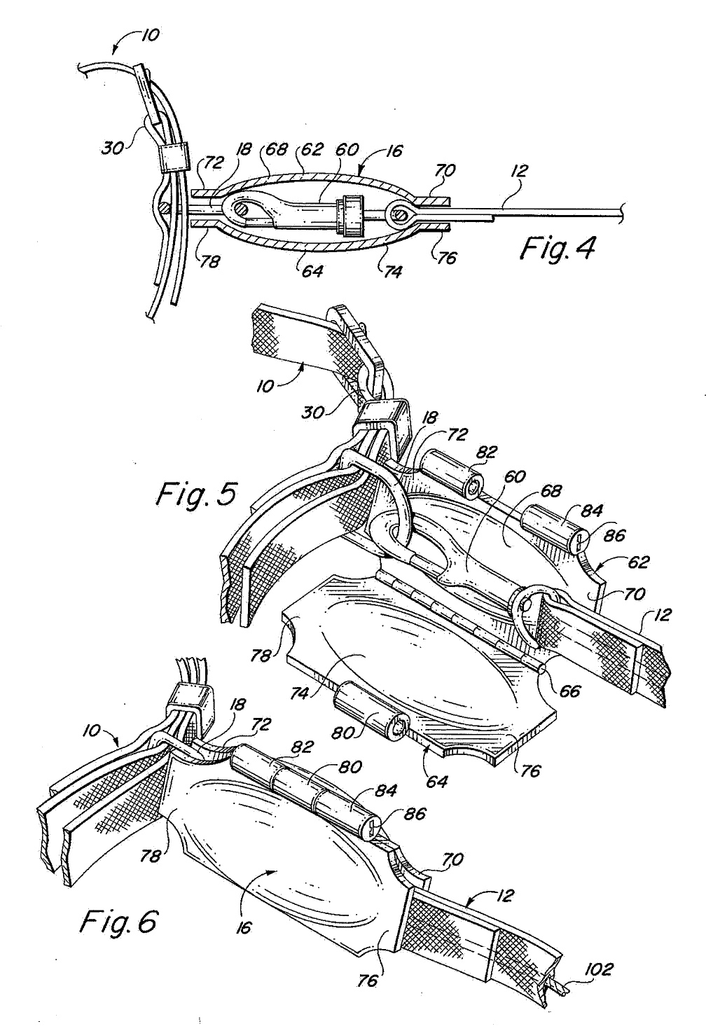

Referring jointly to FIGS. 4, 5, and 6, security device 16 for use in enveloping snap fitting 60 attached to the end of leash 12 is illustrated. Security device 16 may be the same as or similar to security device 14. That is, the space enveloped by each of security devices 14 and 16 must be sufficient to accommodate the enveloped item, whether it be a buckle or a snap fitting. Generally, the same size of security device may be used for each of the buckle and snap fitting.

Security device 16 includes two clamshell-like elements 62, 64 having adjacent edges hingedly attached to one another by a hinge 66. Element 62 includes an extended dome 68 terminated at opposed ends by planar sections 70, 72. Similarly, element 64 includes an extended dome 74 terminated at opposed ends by planar sections 76, 78. The sides of elements 62, 64 opposite to hinge 66 may be lockingly secured to one another, as discussed above with respect to FIG. 2. That is, a cylinder 80 extends from the free edge of element 64 and mates with a pair of cylinders 82, 84 extending from the free edge of element 62. A keyhole 86 in cylinder 84 accommodates insertion of a key to lock and unlock the cylinders mated with one another, as shown in FIG. 6.

In operation, snap fitting 60 at the end of leash 12 is engaged with ring 18, as shown in FIGS. 4 and 5. Security device 16 is mounted over the end of leash 12, snap fitting 60 and a portion of ring 18. Thereafter, it is closed to envelope these items and locked in place, as shown in FIG. 6. As further shown in FIGS. 4 and 6, planar sections 70 and 72 are in close proximity to respective opposed sides of leash 12. Similarly, planar sections 72, 78 are in close proximity to ring 18. Thereby, movement of leash 12 relative to collar 10 during normal walking of an animal will be accommodated by the relatively loose fit between the leash and planar sections 70 and 76 and between ring 18 and planar sections 72, 78. This loose fit will avoid undue strains upon security device 16 and breakage is unlikely.

As particularly illustrated in FIGS. 4 and 5, snap fitting 60 and its attachment mechanism to leash 12 are nested within and enveloped by dome sections 68, 64. The girth of the snap fitting is greater than the distance between planar sections 72, 78. Thereby, sliding movement of security device 16 along the leash to provide access to the snap fitting and ring 18 is precluded. Accordingly, security device 16 provides a strong deterrent against disconnecting the snap fitting from the engaged ring except upon unlocking of the security device.

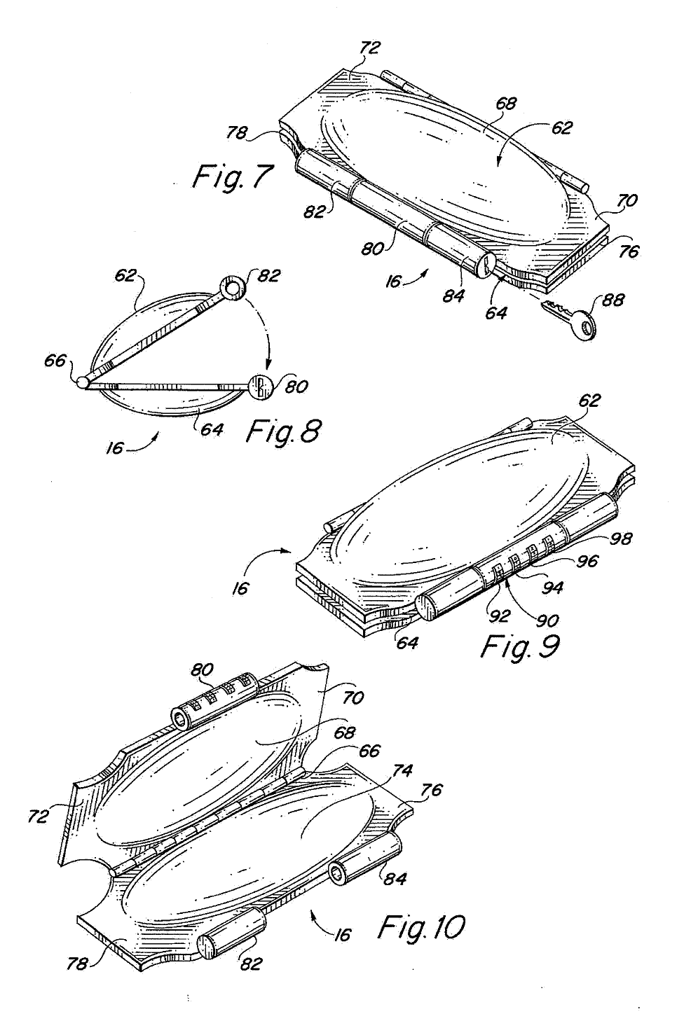

As security devices 14 and 16 may be identical even though they envelop different parts of an animal harness, the illustrations and descriptions relating to FIGS. 7, 8, 9, and 10 are applicable to each security device. To avoid possible confusion, the reference numerals used with respect to security device 16 will be used with respect to the illustrations shown in FIGS. 7, 8, 9, and 10.

Element 62 includes an elongated dome 68 terminated at opposed ends by planar sections 70 and 72. Similarly, the elongated dome section of element 64 is terminated at opposed ends by planar sections 76 and 78. As particularly illustrated in FIGS. 8 and 9, space exists between planar sections 70 and 76 to accommodate the thickness of the leash. Similarly, the space between planar sections 72 and 78 is sufficient to accommodate the thickness of ring 18 extending from collar 10. A key 88 is illustrated to open and close the locking mechanism represented by cylinders 80, 82, and 84.

FIG. 8 particularly shows the opening and closing of security device 16 wherein elements 62, 64 are hingedly attached along one edge by hinge 66. Thereby, this figure illustrates the ease by which security device 16 may be mounted and dismounted about the snap fitting and ring or about the buckle of the collar.

Referring to FIG. 10, there is illustrated security device 16 embodying a thumb wheel lock 90 for lockingly engaging elements 62 and 64 with one another. Such a thumb wheel lock includes a plurality of wheels 92, 94, 96, and 98 having a plurality of indicia on each wheel. When predetermined indicia of each wheel are aligned, the lock will release. After closure of the security device, rotation of at least one of the wheels will set the lock to prevent opening of the security device.

As a further security measure to prevent theft of a leashed animal, a single or multistrand wire 100 may be embedded within collar 10, as shown in FIG. 2. Such a wire will prevent, or at least dissuade, the cutting of the collar by a knife or scissors. Various presently available strands of plastic material may be embedded in place of a wire to accommodate flexibility of the collar and yet provide great resistance against being cut. A similar wire 102 or strand(s) of plastic, as shown in FIG. 6, may be embedded in leash 12 to dissuade cutting of the leash.

1. A security device for enveloping a snap fitting on the end of a leash and partially enveloping a ring extending from an animal collar, said security device comprising:
(a) a first clamshell-like element having a first elongated dome for partially receiving the snap fitting and terminated at each first and second opposed ends;
(b) a first planar section extending about said first elongated dome and forming a part of each of said first and second opposed ends of said first element;
(c) a second clamshell-like element having a second elongated dome for receiving the remaining part of the snap fitting and terminated at each first and second opposed ends;
(d) a second planar section extending about said second elongated dome and forming a part of each of said first and second opposed ends of said second element;
(e) a hinge for pivotally securing one edge of said first element with one edge of said second element and permit opening and closing of said security device about the snap fitting and a part of the ring; and
(f) a lock for securing the other edge of said first element with the other edge of said second element and for accommodating pass-through of a part of the ring between said planar sections at said opposed first ends and pass-through of the leash between said planar sections at said opposed second ends.

2. (canceled)

3. (canceled)

4. (canceled)

5. The security device as set forth in claim 1 wherein said lock comprises first and second spaced apart cylinders extending from said other edge of said first element and a third cylinder extending from said other edge of said second element, said third cylinder being adapted to be interleaved between said first and second cylinders upon closing of said security device.

6. The security device as set forth in claim 5 wherein said lock is a thumb wheel lock.

7. The security device as set forth in claim 5 including a key for locking and unlocking said lock.

8. The security device as set forth in claim 6 including a plurality of thumb wheels disposed in said third cylinder for locking and unlocking said lock upon aligning said thumb wheels in accordance with a code.

9. A security device for enveloping a buckle interconnecting first and second strap ends of a collar, said security device comprising:
(a) a first clamshell-like element having a first elongated dome for partially receiving the buckle and terminated at each first and second opposed ends;
(b) a first planar section extending about said first elongated dome and forming a part of each of said first and second opposed ends of said first element;
(c) a second clamshell-like element having a second elongated dome for receiving the remaining part of the buckle and terminated at each first and second opposed ends;
(d) a second planar section extending about said second elongated dome and forming a part of each of said first and second opposed ends of said second element;
(e) a hinge for pivotally securing one edge of said first element with one edge of said second element and permit opening and closing of said security device about the buckle and the strap ends extending therefrom; and
(f) a lock for securing the other edge of said first element with the other edge of said second element and for accommodating pass-through of the first of the strap ends between said planar sections at said first opposed ends and pass-through of the second of the strap ends between said planar sections at said second opposed ends.

10. The security device as set forth in claim 9 wherein said lock comprises first and second spaced apart cylinders extending from said other edge of said first element and a third cylinder extending from said other edge of said second element, said third cylinder being adapted to be interleaved between said first and second cylinders upon closing of said security device.

11. The security device as set forth in claim 10 including a key for locking and unlocking said lock.

12. The security device as set forth in claim 10 including a plurality of thumb wheels disposed in said third cylinder for locking and unlocking said lock upon aligning said thumb wheels in accordance with a code.

13. (canceled)

14. (canceled)

15. (canceled)

16. A security device for enveloping a detachably attached fastening having first and second strap ends extending from opposed ends of the fastening, said security device comprising:
(a) a first clamshell-like element having a first elongated dome for partially receiving said fastening and terminated at each first and second opposed ends;
(b) a first planar section extending about said first elongated dome and forming a part of each of said first and second opposed ends of said first element;
(c) a second clamshell-like element having a second elongated dome for receiving the remaining part of the fastening and terminated at each first and second opposed ends;
(d) a second planar section extending about said second elongated dome and forming a part of each of said first and second opposed ends of said second element;
(e) a hinge for pivotally securing one edge of said first element with one edge of said second element and permit opening and closing of said security device about the fastening and the strap ends extending therefrom; and
(f) a lock for securing the other edge of said first element with the other edge of said second element and for accommodating pass-through of the first strap ends between said planar sections at said first opposed ends and pass-through of the second strap ends between said planar sections at said second opposed ends.

17. The security device as set forth in claim 16 wherein said lock comprises first and second spaced apart cylinders extending from said other edge of said first element and a third cylinder extending from said other edge of said second element, said third cylinder being adapted to be interleaved between said first and second cylinders upon closing of said security device.

18. The security device as set forth in claim 17 including a key for locking and unlocking said lock.

19. The security device as set forth in claim 17 including a plurality of thumb wheels disposed in said third cylinder for locking and unlocking said lock upon aligning said thumb wheels in accordance with a code.
